(19) United States
(12) Patent Application Publication
(10) Pub. No.: US 2010/0088433 A1
(43) Pub. Date: Apr. 8, 2010

(54) Direct memory access (DMA) system

(75) Inventor: Sung-Jung Wang, Taipei County (TW)

Correspondence Address: BACON & THOMAS, PLLC, 625 SLATERS LANE, FOURTH FLOOR, ALEXANDRIA, VA, 22314-1176, US

(73) Assignee: AN CHEN COMPUTER CO., LTD., Taipei County (TW)

(21) Appl. No.: 12/285,393

(22) Filed: Oct. 3, 2008

(51) Int. Cl. G06F 13/28

(52) U.S. Cl. 710/22

(57) ABSTRACT

A direct memory access (DMA) system includes a memory unit, a memory control unit electrically connected to the memory unit to control the memory unit for data import or data export, a memory bus is electrically connected to the memory unit, an intermediate control unit electrically connected to the memory bus to receive data of the memory unit through the memory bus, and a plurality of DMA units, each of which includes a DMA controller electrically connected to the intermediate control unit and the memory control unit and a data in/out unit electrically connected to the DMA controller and the intermediate control unit. The DMA controllers control the data in/out units to receive data from the intermediate control unit. The present invention may reduce the load on bandwidth of the memory bus 31 and speed up the data transmission.

### BACKGROUND OF THE INVENTION

1. Field of the Invention

The present invention relates to a direct memory access (DMA) technique in a computer system and more particularly, to a high speed data transmission DMA system.

2. Description of the Related Art

As shown in FIG. 2, a conventional DMA system 70 includes a memory 71 and a memory control unit 72 to control the memory 71. A memory bus 73 is provided for data transmission, and a plurality of DMA units 75, each of which has a DMA controller 76 and a First In, First Out (FIFO) memory 77 are connected to the memory bus 73.

In the conventional DMA system, each DMA unit is independent and acquires the memory bus 73 individually to complete the data transmission from the memory 71 to the target device. When there are a lot of the DMA units 75 in the system, or the system is a duplicating system or a disk matrix having a lot of the DMA units 75, it will generate a heavy load on bandwidth because the DMA units and CPU will acquire the memory bus respectively.

### SUMMARY OF THE INVENTION

The primary objective of the present invention is to provide a DMA system, which it only has to acquire the data bus once that may transmit data to each DMA unit when the data provided to the DMA units are the same. The present invention may speed up the data transmission and reduce the load on bandwidth.

To achieve the objective of the present invention, A direct memory access (DMA) system includes a memory unit, a memory control unit electrically connected to the memory unit to control the memory unit for data import or data export, a memory bus is electrically connected to the memory unit, an intermediate control unit electrically connected to the memory bus to receive data of the memory unit through the memory bus, and a plurality of DMA units, each of which includes a DMA controller electrically connected to the intermediate control unit and the memory control unit and a data in/out unit electrically connected to the DMA controller and the intermediate control unit. The DMA controllers control the data in/out units to receive data from the intermediate control unit. The present invention may reduce the load on bandwidth of the memory bus 31 and speed up the data transmission.

### BRIEF DESCRIPTION OF THE DRAWINGS

FIG. 1 is a block diagram of a preferred embodiment of the present invention; and

FIG. 2 is a block diagram of the conventional DMA system.

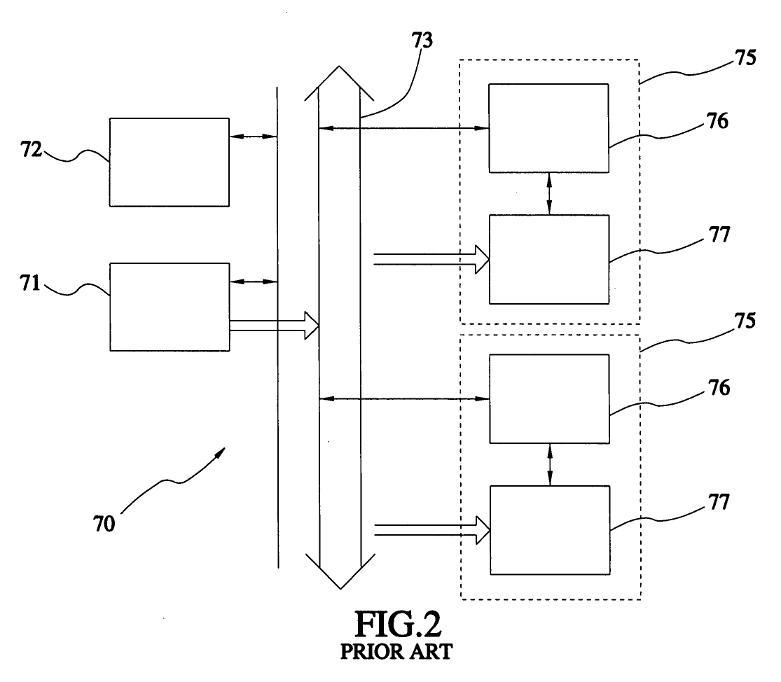

### DETAILED DESCRIPTION OF THE INVENTION

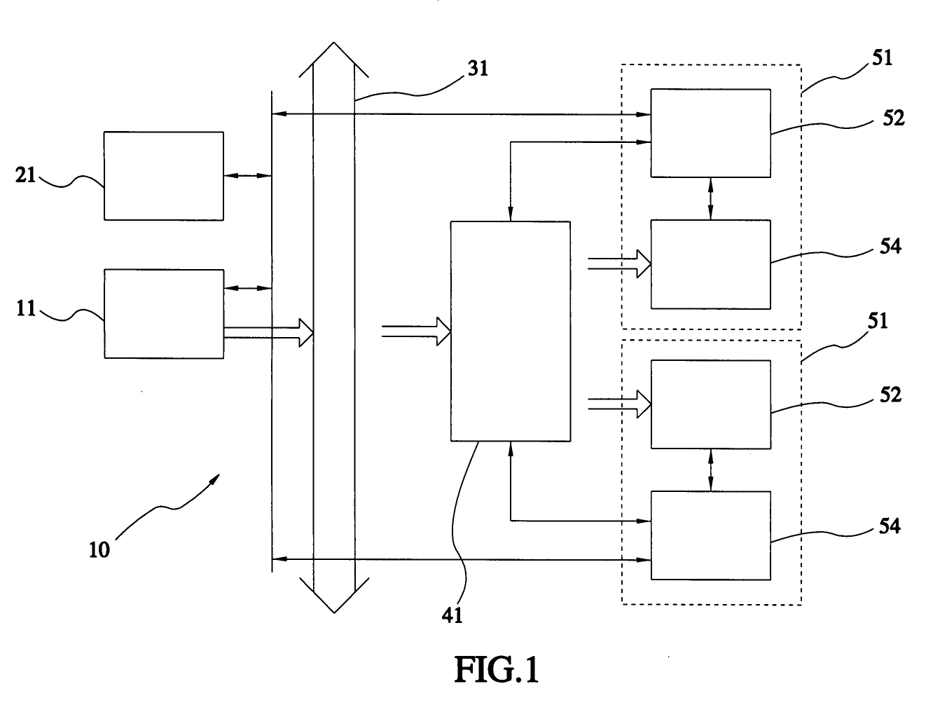

Referring to FIG. 1, a direct memory access (DMA) of the preferred embodiment of the present invention includes a memory unit 11, a memory control unit 21, a memory bus 31, an intermediate control unit 41, and a plurality of DMA units 51.

The memory control unit 21 is electrically connected to the memory unit 11 to control the memory unit 11 for data import or data export.

The memory bus is electrically connected to the memory unit 11.

The intermediate control unit 41 is electrically connected to the memory bus 31 to receive data of the memory unit 21 through the memory bus 31.

Each of the DMA units 51 includes a DMA controller 52 and a data in/out unit 54, wherein the DMA controller 52 is electrically connected to the intermediate control unit 41 and the memory control unit 21, and the data in/out unit 54, which is a First In, First Out (FIFO) memory in the present invention, is electrically connected to the DMA controller 52 and the intermediate control unit 41. The DMA controller 52 will control the data in/out unit 54 to receive the data from the intermediate control unit 51.

In operation, when plural data in the memory unit 11 have to be transmitted to different target devices, a software of a computer system will check whether the data are the same first. For example, a specific software, which is a known technique, may observe whether the data have the same memory address to determine whether the data are the same. When the data are not the same, the intermediate control unit 41 is controlled to bypass the data from the memory unit 11 directly to the corresponding DMA units through the intermediate control unit 41.

When the memory unit 11 has the data therein to be transmitted to the target devices, it should check whether the data are the same by a specific software of the computer system also. If the check result is the same, suppose there are three same data, one of the data will be transmitted to the intermediate control unit 41 from the memory unit 11, and then is transmitted to three of the corresponding DMA units 51.

As a result, it only needs to read a medium in the memory unit 11 once and transmit the medium to all of the corresponding DMA units 51 when there are many the same data to be transmitted. It may reduce the load on bandwidth of the memory bus 31 and speed up the data transmission.

In conclusion, the system of the present invention may reduce the load on bandwidth of the memory bus 31 and speed up the data transmission.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A direct memory access (DMA) system, comprising:
a memory unit;
a memory control unit electrically connected to said memory unit to control said memory unit for data import or data export;
a memory bus is electrically connected to said memory unit;
an intermediate control unit electrically connected to said memory bus to receive data of the memory unit through said memory bus; and
a plurality of DMA units, each of which includes a DMA controller electrically connected to said intermediate control unit and said memory control unit and a data in/out unit electrically connected to said DMA controller and said intermediate control unit, wherein said DMA controllers control said data in/out units to receive data from said intermediate control unit.

2. The DMA system as claimed in claim 1, wherein said intermediate control unit receives data from said memory bus, and then transmits said data to at least one of said DMA controllers.

3. The DMA system as claimed in claim 1, wherein said data in/out unit is a First in, First Out (FIFO) memory.
